(19) United States
(12) Patent Application Publication
(10) Pub. No.: US 2021/0364278 A1
(43) Pub. Date: Nov. 25, 2021

(54) Method And Device For Measuring Apex Radius Of Optical Element Based On Computer-Generated Hologram

(71) Applicant: The Institute of Optics and Electronics, The Chinese Academy of Sciences, Chengdu (CN)

(72) Inventors: Gaofeng WU, Chengdu (CN); Qiang Chen, Chengdu (CN); Weihong Song, Chengdu (CN); Xi Hou, Chengdu (CN)

(21) Appl. No.: 16/626,952

(22) PCT Filed: Jan. 10, 2019
(86) PCT No.: PCT/CN2019/071182

§ 371 Date: Dec. 27, 2019

(30) Foreign Application Priority Data
Jun. 27, 2018 (CN) 201810676220.4

(51) Int. Cl. G01B 11/255; G01B 11/24

(52) U.S. Cl. CPC G01B 11/255; G01B 11/2441

(57) ABSTRACT

The disclosure relates to a measuring method and a measuring device for measuring a radius of an optical element based on a computer-generated hologram, and belongs to the field of photoelectric technology detection. The present disclosure is characterized in that two conjugated wave surfaces, i.e. a confocal wavefront and a cat's eye wavefront, are simultaneously generated by one piece of computer-generated hologram, and at the same time, interferograms at the cat's eye position and at the confocal position are obtained and surface shape parameters are measured, and the radius of an optical element is solved according to the measurement result.

### CROSS-REFERENCE TO RELATED APPLICATIONS

This application is a U.S. National Phase application under 35 U.S.C. § 371 of International Application No. PCT/CN2019/071182, filed on Jan. 10, 2019 and entitled with “Method And Device For Measuring Apex Radius Of Optical Element Based On Computer-generated Hologram”, which claims priority to Chinese Application No. 201810676220.4, filed on Jun. 27, 2018, the contents of which are incorporated herein by reference in their entirety.

### FIELD OF THE DISCLOSURE

The disclosure relates to the field of optical manufacturing and detection, and in particular to an optical detecting device for measuring an apex radius of an optical element.

### DESCRIPTION OF THE RELATED ART

A lens is a primary element in an optical system. A radius of curvature of an optical element is one of important parameters that determine the optical properties of the optical element and is one of important indicators for judging processing quality of the optical element during manufacturing.

Measurement methods for a radius of curvature of a spherical surface can be divided into two types: contact type and non-contact type. These measurement methods generally utilize the following four types of principles: indirectly obtaining the radius of curvature by measuring the sag of the spherical surface to be measured; scanning the surface shape of the spherical surface to be measured and obtaining the radius of curvature by a fitting calculation; obtaining the radius of curvature by directly measuring the curvature of the spherical surface to be measured, and obtaining the radius of curvature by directly measuring a relative distance between a position of center of the surface to be measured and a center of the sphere. The contact measurement method mainly includes spherical template method, Newton's ring method, spherometer method, three-coordinate measurement method and laser tracker method. The non-contact measurement method mainly includes knife shadow method, self-collimation microscope method, laser interferometry method, laser differential confocal method and the like.

The laser interferometry method utilizes laser interference to measure the radius of curvature of the optical element, in which an interferometer (such as Fizeau interferometer), an axial translation guide rail, a five-dimensional adjustment mount, and a precision distance measuring system (e.g. laser ranging interferometer) that can record the moving positions are required. The basic principle of the laser interferometry method is to translate the optical element to be measured along the guide rail during measurement. The position of a vertex and the position of a center of curvature of the surface to be measured are determined by observing the interference fringes on the interferometer. When the convergence point of a standard lens coincides with the center of curvature of the surface to be measured, zero fringe will be observed. When the convergence point of the standard lens coincides with the position of the vertex of the spherical surface to be measured, a reflected spherical wavefront is flipped relative to an incident spherical wavefront. That is, the light incident on the spherical surface to be measured is reflected at the same angle, and zero fringe can also be observed in the field of view. Finally, the relative distance between the two positions is measured to obtain the radius of curvature of the optical element (see FIG. 6 for example).

There are in this method an Abbe error and a measurement system error introduced by the angle between the measuring axis and the optical axis due to the movement of two positions. Therefore, on this basis, a method and a device for measuring the radius based on a computer-generated hologram are proposed, in which the Abbe error of the laser interferometry method can be eliminated and the measurement accuracy can be improved since there is no moving mechanism.

### SUMMARY

According to an aspect of the disclosure, there is provided a measuring device for measuring an apex radius of an optical element based on a computer-generated hologram, characterized by including: an interferometer (1), a computer-generated hologram (2), a piece to be measured (3), and a standard lens (6), wherein the computer-generated hologram includes three parts including: a holographic alignment annulus (7), a cat's eye alignment annulus (8), and a primary measurement hologram (9); wherein an entire measurement optical path includes three portions including: a holographic alignment measurement optical path, a cat's eye alignment measurement optical path, and a primary hologram measurement optical path. The holographic alignment measurement optical path is configured to accurately align a position of the computer-generated hologram in the optical path, the cat's eye alignment measurement optical path is configured to accurately position the piece to be measured (3) in a designed position in the measurement optical path, and the primary hologram measurement optical path is configured to measure a surface shape of an optical surface and to utilize measurement data to calculate the apex radius of the optical element.

According to one embodiment of the disclosure, the holographic alignment annulus (7) is configured to adjust the computer-generated hologram to a designed theoretical position; a cat's eye alignment annulus (8) is configured to adjust a convergence point, which is originally concentrated at an focal position of a lens, to a center of the piece to be measured; and the primary measurement hologram (9) is configured to measure the surface shape of the piece to be measured.

According to one embodiment of the disclosure, the computer-generated hologram is adjusted to the designed position by means of the holographic alignment annulus at outermost side of the computer-generated hologram, and there is a smallest focal power of the holographic alignment annulus at the designed position.

According to an embodiment of the present disclosure, the piece to be measured is adjusted to a designed cat's eye position by means of the cat's eye alignment annulus of the computer-generated hologram.

According to an embodiment of the disclosure, the radius of an apex of the piece to be measured is obtained from a measurement result of the primary measurement hologram.

According to an embodiment of the disclosure, the piece to be measured has a concave spherical surface.

According to another aspect of the present disclosure, the piece to be measured has a convex spherical surface.

According to another aspect of the present disclosure, there is provided a method for measuring an apex radius of an optical element using the above measuring device, including steps of:

building an optical path and adjusting the computer-generated hologram, so that there is no inclination of the computer-generated hologram and defocus phase difference in measurement results for the holographic alignment annulus;

adjusting the optical element to be measured such that the apex of the optical element is positioned at a focal point of diffraction of the cat's eye alignment annulus and such that there is no inclination of the computer-generated hologram and defocus in measurement results for the cat's eye alignment annulus;

performing a measurement of the optical element by means of diffraction of the primary measurement hologram; and

calculating the radius of the optical element based on the measurement result.

The technical solution adopted by the present disclosure is described as follows: a measuring device for measuring an apex radius of an optical element based on a computer-generated hologram, including: an interferometer (1), a computer-generated hologram (2), a piece to be measured (3), and a standard lens (6). The computer-generated hologram includes three parts including: a holographic alignment annulus (7), a cat's eye alignment annulus (8), and a primary measurement hologram (9). An entire measurement optical path includes three portions including: a holographic alignment measurement optical path, a cat's eye alignment measurement optical path, and a primary hologram measurement optical path. The holographic alignment measurement optical path is configured to accurately align a position of the computer-generated hologram in the optical path, the cat's eye alignment measurement optical path is configured to accurately position the piece to be measured in a designed position in the measurement optical path, and the primary hologram measurement optical path is configured to measure a surface shape of an optical surface and to utilize measurement data to calculate the apex radius of the optical element.

### BRIEF DESCRIPTION OF THE DRAWINGS

FIG. 1 is a schematic structural view of a measuring device according to the present disclosure;

FIG. 2 is a schematic structural view of a computer-generated hologram;

FIG. 3 is a schematic view of a holographic alignment measurement optical path;

FIG. 4 is a schematic view of a cat's eye holographic measurement optical path;

FIG. 5 is a schematic diagram of a primary hologram measurement optical path.

FIG. 6 is a schematic view of a laser interferometry measurement optical path.

### DETAILED DESCRIPTION OF EMBODIMENTS

The disclosure will be described in detail below with reference to the drawings and specific embodiments.

It is an object of the disclosure to provide a measuring device for measuring an apex radius of an optical element based on a computer-generated hologram. The device is based on holographic interferometry measurement optical path, and there is no need for movement of the optical element. The radius of the optical element is calculated by measuring the surface shape of the surface of the optical element, thereby eliminating systematic errors and improving the measurement accuracy.

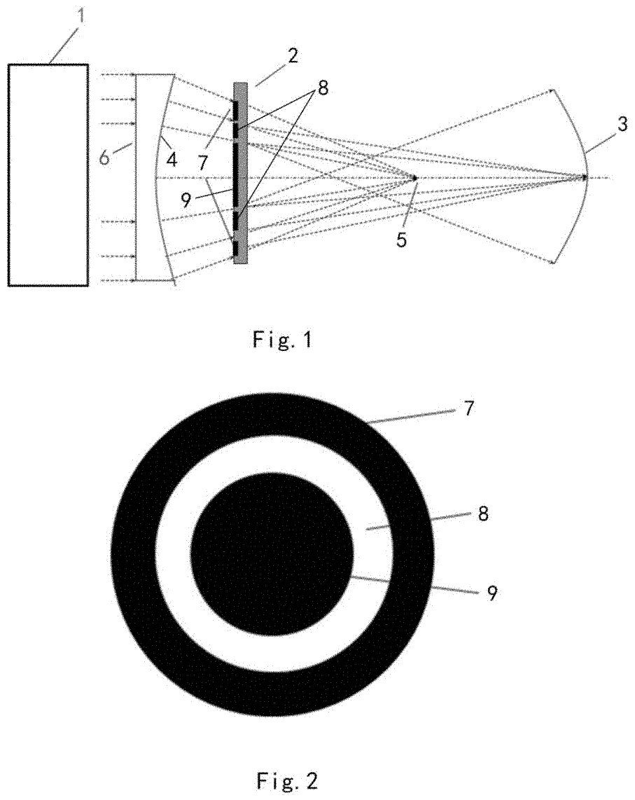

As shown in FIG. 1, a measuring device for measuring an apex radius of an optical element based on a computer-generated hologram includes an interferometer (1), a computer-generated hologram (2), a piece to be measured (3), and a standard lens (6). The computer-generated holographic structure designed herein is shown in FIG. 2 and includes a holographic alignment annulus (7), a cat's eye alignment annulus (8), and a primary measurement hologram (9).

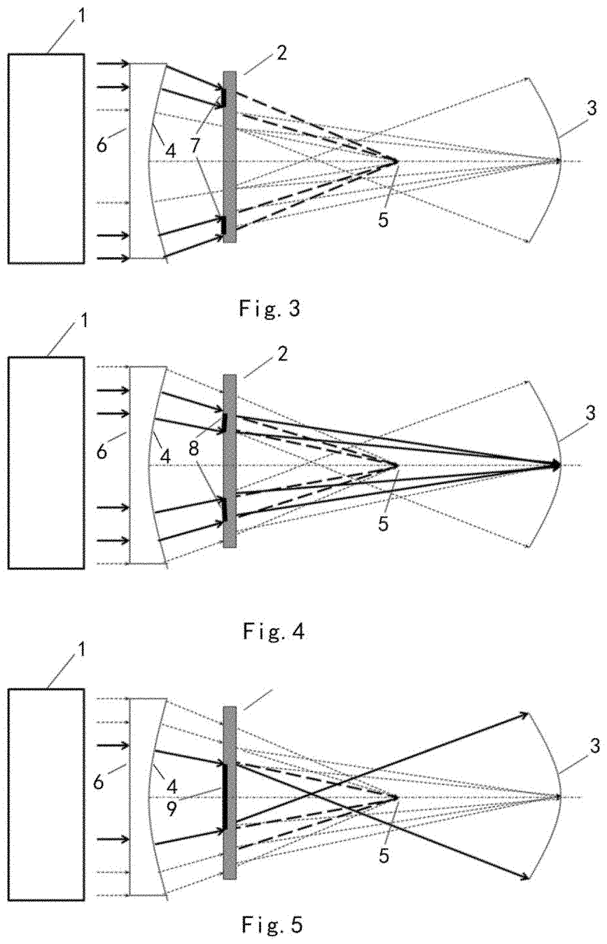

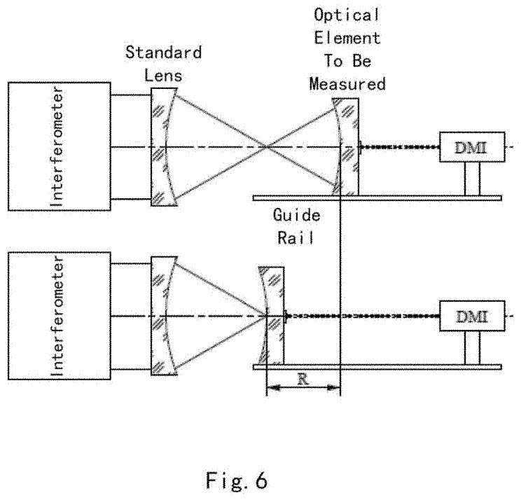

As shown in FIGS. 2-5, an entire measurement optical path includes three portions (FIG. 2): a holographic alignment measurement optical path (FIG. 3), a cat's eye alignment measurement optical path (FIG. 4), and a primary hologram measurement optical path (FIG. 5). The holographic alignment measurement optical path is configured to accurately align a position of the computer-generated hologram in the optical path, the cat's eye alignment measurement optical path is configured to accurately position the piece to be measured (3) in a designed position in the measurement optical path, and the primary hologram measurement optical path is configured to measure a surface shape of an optical surface and to utilize the measurement data to calculate the apex radius of the optical element.

As shown in FIG. 2, the computer-generated hologram is configured to have three annuluses: a holographic alignment annulus (7) configured to adjust the computer-generated hologram to a designed theoretical position; a cat's eye alignment annulus (8) configured to adjust a convergence point, which is originally concentrated at an focal position of an lens, to a center of the piece to be measured; and a primary measurement hologram (9) configured to measure the surface shape of the piece to be measured.

In one embodiment, the computer-generated hologram is adjusted to the designed position by means of the holographic alignment annulus at outermost side of the computer-generated hologram, and there is a smallest focal power of the annulus at the designed position.

In one embodiment, the piece to be measured is adjusted to a designed cat's eye position by means of the cat's eye alignment annulus of the computer-generated hologram (FIG. 4).

In one embodiment, the apex radius of the piece to be measured is obtained from a measurement result of the primary measurement hologram (FIG. 5).

In one embodiment, the piece to be measured has a concave spherical surface.

In one embodiment, the piece to be measured has a convex spherical surface.

During the measurement, the interferometer 1 emits a parallel beam. The parallel beam passes through the standard lens 6 and then the laser beam reaching different areas of the computer-generated hologram 2 is transmitted by diffraction.

After the light to the holographic alignment annulus at outermost side of the computer-generated hologram directly returns according to a designed diffraction light path, the position of the computer-generated hologram is adjusted so that reference light reflected at a reference surface 4 by the standard lens interferes with the light from the holographic alignment annulus. The inclination and displacement of the computer-generated hologram are adjusted such that the computer-generated hologram is accurately positioned (FIG. 3).

After the light to the cat's eye alignment annulus located at a middle annulus position of the computer-generated hologram transmits through the computer-generated hologram by diffraction, the position of the piece to be measured is adjusted so that the light is reflected back to the interferometer after focusing on the center of the piece to be measured, and interferes with the reference light reflected by the standard lens. During this adjustment, the defocus value of this area is adjusted to the minimum.

After the light to the primary measurement hologram of the computer-generated hologram transmits through the computer-generated hologram by diffraction, the diffracted light returns when reaching the optical element to be measured, finishing the measurement of the optical surface shape.

The measurement process and measurement steps of the device of the present disclosure are described as follows:

Step 1: as shown in FIG. 3, building an optical path and adjusting the computer-generated hologram, so that there is no inclination of the computer-generated hologram and defocus phase difference in measurement results for the holographic alignment annulus;

Step 2: as shown in FIG. 4, adjusting the optical element to be measured such that the apex of the optical element is positioned at a focal point of diffraction of the cat's eye alignment annulus and such that there is no inclination of the computer-generated hologram and defocus in measurement results for the cat's eye alignment annulus;

Step 3: as shown in FIG. 5, performing a measurement of the optical element by means of diffraction of the primary measurement hologram; and

Step 4: calculating the radius of the optical element based on the measurement results. In the measurement results of the primary measurement hologram, there will be a defocus value in the results of the interferometer due to error in the radius. The relationship between the defocus value (P) and the radius is:

Δ_{R} defocus=−8(R/D)²×P

where R is a nominal radius, D is a diameter of the piece to be measured, and P is the defocus value measured by the interferometer.

The disclosure has the following advantages over the prior art:

1. The interferometric technology is utilized, the cat's eye confocal position has a high positioning accuracy and there is a high measurement accuracy for radius.

2. Compared with the commonly used laser interferometry, since the movement between the cat's eye position and the confocal position is not required, the error introduced by the angle between the optical axis and the moving axis is eliminated, and the measurement accuracy is improved.

The above is only a specific implementation of the present disclosure, and the scope of protection of the present disclosure will be not limited thereto. Any modification or replacement made by those skilled in the art within the technical scope disclosed by the present disclosure should fall within the scope of the present disclosure.

1. A measuring device for measuring an apex radius of an optical element based on a computer-generated hologram, comprising: an interferometer, a computer-generated hologram, a piece to be measured, and a standard lens;
wherein the computer-generated hologram comprises a holographic alignment annulus, a cat's eye alignment annulus, and a primary measurement hologram;
wherein an entire measurement optical path comprises: a holographic alignment measurement optical path, a cat's eye alignment measurement optical path, and a primary hologram measurement optical path,
wherein the holographic alignment measurement optical path is configured to accurately align a position of the computer-generated hologram in the optical path; the cat's eye alignment measurement optical path is configured to accurately position the piece to be measured in a designed position in the measurement optical path; and the primary hologram measurement optical path is configured to measure a surface shape of an optical surface and to utilize measurement data to calculate the apex radius of the optical element.

2. The measuring device according to claim 1, wherein the holographic alignment annulus is configured to adjust the computer-generated hologram to a designed theoretical position; the cat's eye alignment annulus is configured to adjust a convergence point of the standard lens, which is originally concentrated at an focal position of a lens, to a center of the piece to be measured; and the primary measurement hologram is configured to measure the surface shape of the piece to be measured.

3. The measuring device according to claim 1,
wherein the computer-generated hologram is adjusted to the designed position by means of the holographic alignment annulus at outermost side of the computer-generated hologram, and
wherein there is a smallest focal power of the holographic alignment annulus at the designed position.

4. The measuring device according to claim 1, wherein the piece to be measured is adjusted to a designed cat's eye position by means of the cat's eye alignment annulus of the computer-generated hologram.

5. The measuring device according to claim 1, wherein a radius of an apex of the piece to be measured is obtained from a measurement result of the primary measurement hologram.

6. The measuring device according to claim 1, wherein the piece to be measured has a concave spherical surface.

7. The measuring device according to claim 1, wherein the piece to be measured has a convex spherical surface.

8. A method for measuring an apex radius of an optical element using the measuring device according to claim 1, comprising steps of:
building an optical path and adjusting the computer-generated hologram, so that there is no inclination of the computer-generated hologram and defocus phase difference in measurement results for the holographic alignment annulus;
adjusting the optical element to be measured such that the apex of the optical element is positioned at a focal point of diffraction of the cat's eye alignment annulus and such that there is no inclination of the computer-generated hologram and defocus in measurement results for the cat's eye alignment annulus;
performing a measurement of the optical element by means of diffraction of the primary measurement hologram; and
calculating the radius of the optical element based on the measurement results.

9. The method of claim 8, wherein the holographic alignment annulus is configured to adjust the computer-generated hologram to a designed theoretical position; the cat's eye alignment annulus is configured to adjust a convergence point of the standard lens, which is originally concentrated at an focal position of a lens, to a center of the piece to be measured; and the primary measurement hologram is configured to measure the surface shape of the piece to be measured.

10. The method of claim 8,
wherein the computer-generated hologram is adjusted to the designed position by means of the holographic alignment annulus at outermost side of the computer-generated hologram, and
wherein there is a smallest focal power of the holographic alignment annulus at the designed position.

11. The method of claim 8, wherein the piece to be measured is adjusted to a designed cat's eye position by means of the cat's eye alignment annulus of the computer-generated hologram.

12. The method of claim 8, wherein a radius of an apex of the piece to be measured is obtained from a measurement result of the primary measurement hologram.

13. The method of claim 8, wherein the piece to be measured has a concave spherical surface.

14. The method of claim 8, wherein the piece to be measured has a convex spherical surface.
